(19) United States
(12) Patent Application Publication
(10) Pub. No.: US 2026/0047651 A1
(43) Pub. Date: Feb. 19, 2026

(54) WEARABLE RING WITH EMBEDDED WIRE SAW

(71) Applicant: Daniel Lawrence Markovich, Falls Church, VA (US)

(72) Inventor: Daniel Lawrence Markovich, Falls Church, VA (US)

(21) Appl. No.: 18/808,461

(22) Filed: Aug. 19, 2024

(51) Int. Cl. A44C 9/00; B26B 27/00

(52) U.S. Cl. CPC A44C 9/0069; B26B 27/002

(57) ABSTRACT

A wearable concealed saw device having a wire saw removably embedded in a ring dimensioned and adapted to inconspicuously worn on a finger of a wearer. When embedded, the diamond wire saw is in a coiled condition so that when removed from the ring the wire saw is movable to an uncoiled condition for sawing. The wire saw may be diamond-coated wire. The ring may be made of silicone to facilitate the removable embedment and allow the wearer to easily change the color and tone of the silicone material to match the skin of the wearer or an incognito tone.

### BACKGROUND OF THE INVENTION

The present invention relates to saws and, more particularly, to a concealed wire saw embedded in a wearable ring for use during emergencies.

Traveling abroad and within the United States can be dangerous. Kidnapping and hostage-taking is a daily occurrence without any warning to prepare. Predictably, the capturers typically will use restraints of common materials which are unfortunately sufficient to render the victim passive. The victim cannot defeat or cut through the restraint without some form of serrated device.

Though “escape wearables” are not a new concept and are available, they are expensive, are obvious when worn, and do not offer sufficiently resilient cutting edge to escape from multiple commonly used restraint devices. Most such offerings provide just a concealed handcuff key or a poor-quality, rigid, approximately one inch or smaller blade that dulls quickly and the wearable is extremely uncomfortable for daily use.

As can be seen daily in the news, there is a need for a concealed wire saw embedded in a wearable ring for use during emergencies.

### SUMMARY OF THE INVENTION

The present invention may be made of a comfortable silicone ring that has no appearance of an embedded diamond wire for sawing through most restraint. Incognito, strong and comfortable, the present invention can be ready at a moment's notice to provide strong and versatile cutting.

No other available product has flexible diamond cutting saw wire imbedded in the silicone, wherein the silicone enables the color and texture of the ring to blend into its surroundings. The cutting strength of the diamond cutting saw wire works on a multitude of materials, while the underlying thread, filament, wire or the like enables the formation of flexible loops that can selectively uncoil only when needed.

The ring embodied in the present invention is incognito, showing no signs of an escape apparatus, and can be made of comfortable silicone of a generic tone, black, or that matches that of the wearer's skin color, while the coiled saw wire removably embedded in the ring can provide cut power in an uncoiled condition that can cut through common restraints with minimal training.

The present invention embodies a concealed innocuous wearable ring with a restraint escape device readily available for peace of mind and functionality. The present invention provides an imbedded escape diamond coated saw wire in a wearable ring to always be ready with comfort and flexibility for cutting the most common restraint devices so that the wearer can escape therefrom.

The present invention is configured to be comfortably worn twenty-four hours a day, is a selectable common color and material that blends into its surroundings and inconspicuously provide an embedded diamond saw escape device. No other product has an escape device embedded within silicone to avoid visible evidence thereof. Also, the embedded saw embodied in the present invention can cut the most common restraint device while providing inherent flexibility for the unknown.

In one aspect of the present invention, a method of conceal carry of a wire saw includes the following steps: embedding the wire saw in a ring dimensioned and shaped to inconspicuously be worn on a finger of a wearer, wherein the wire saw is in a coiled condition movable to an uncoiled condition for sawing, and covering the ring with a layer that makes the wire saw invisible.

In another aspect of the present invention, a wearable saw device provides the following: a ring dimensioned and adapted to be inconspicuously worn on a finger of a wearer; a wire saw, in a coiled condition, embedded in a body of the ring, wherein the wire saw is movable to an uncoiled condition for sawing after being removed from the body of the ring, wherein the wire saw comprises a diamond coated wire; and an arcuate cover layer snugly circumscribing an exterior surface of the ring, thereby encasing the wire saw, wherein the ring and the cover layer are made of silicone colored to match a skin color of the wearer, and wherein a recessed channel is provided along the exterior surface of the ring for nesting the wire saw in the coiled condition. The wire saw may be adhered or tied in the coiled condition.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in a worn condition.

FIG. 2 is a perspective view of an exemplary embodiment of the present invention, shown in a concealed condition.

FIG. 3 is an exploded perspective view of an exemplary embodiment of the present invention.

FIG. 4 is a section view of an exemplary embodiment of the present invention, taken along line 4-4 in FIG. 2.

FIG. 5 is a perspective view of an exemplary embodiment of a filament 12 of the present invention, shown in a partial coiled and partially uncoiled condition.

FIG. 6 is an elevation view of an exemplary embodiment of the wire of the present invention, shown in a taut, uncoiled condition, ready for sawing.

FIG. 7 is a flow chart 700 of an exemplary embodiment of a system of the present invention, illustrating systemic components 702, 704, 706, and 708.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

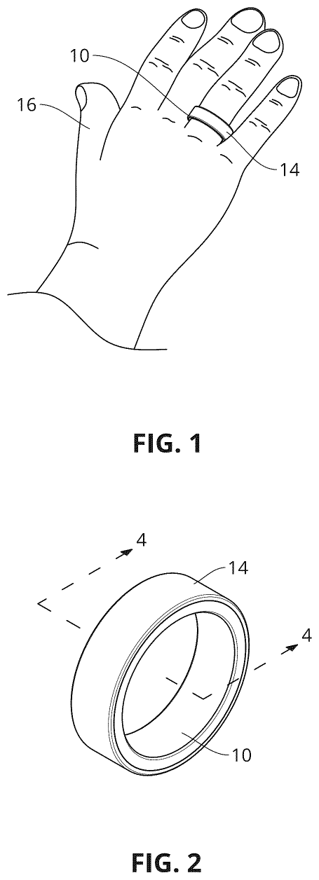

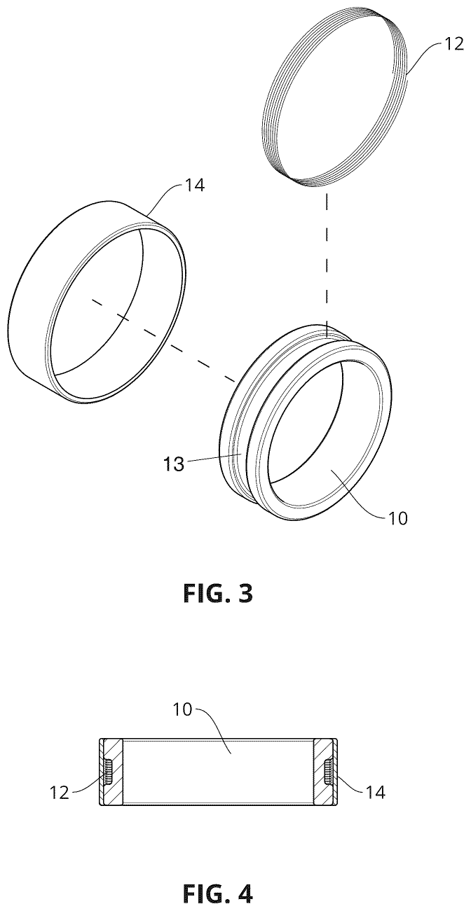

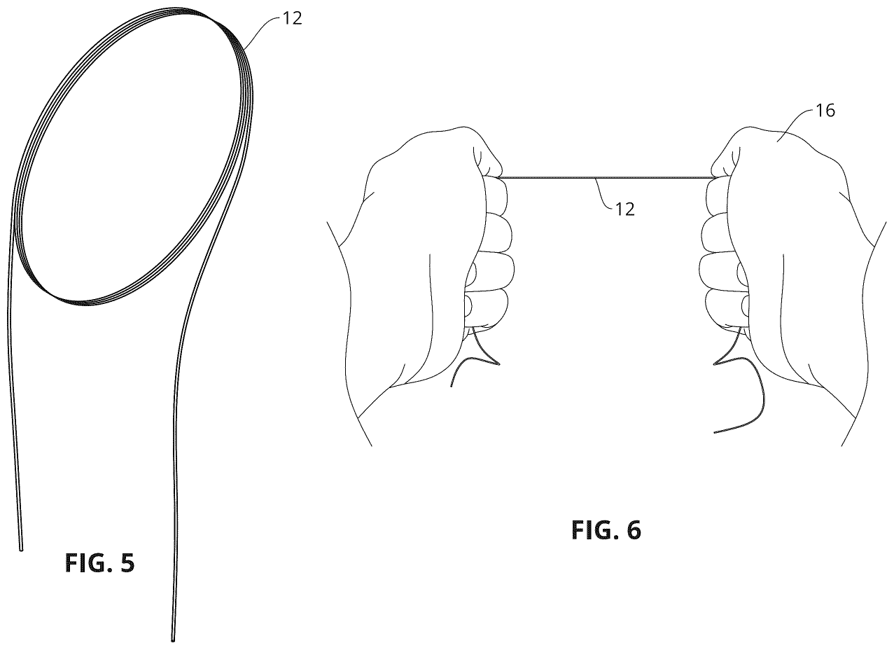

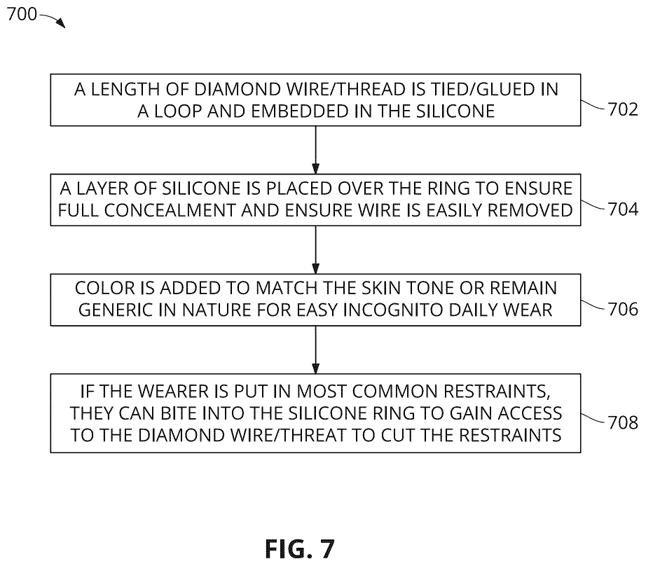

Referring to FIGS. 1 through 7, the present invention may include a wearable ring 10 made of silicone (though other materials are possible if they provide the functionality disclosed herein).

The length of filament 12 is wrapped and joined in a loop condition, and the loop of filament 12 is embedded in the wearable ring 10. The filament 12 may be a diamond cutting wire or thread with the strength and cutting edge to saw through common wrist and body restraints (e.g., zip/cable ties, duct tape, rope, flexicuffs, etc.), see systemic component 702. The filament 12 may have a length of one half of a meter or more and have a diameter of approximately one-quarter of a millimeter or less. Though other lengths and diameters are contemplated, if in the coiled condition, the filament can be concealed and embedded in a ring 10 that does not stand out as too bulky or suggestive of concealing an escape tool.

An arcuate cover layer 14 may be placed over the ring 10 to ensure full concealment of the loop of filament 12 yet providing removably of the loop of filament 12 from the ring 10, see systemic component 704. The cover layer 14 may also be made of silicone or equivalent. The cover layer 14 may be dimensioned and sized to partially plug into, and thereby secure to, a recess 13 in which the loop of filament 12 is housed.

Color and texture may be added to the material of the ring 10 and the material of the cover layer 14 so that they match or blend with the color and texture of the skin of the wearer 16 or another adjacent wearable, or otherwise appear generic, thereby making the ring 10 incognito during daily wear, see systemic component 706.

When needed, if the wearer 16 is put in common restraints, then the cover layer 14 can be removed, bitten into, or otherwise torn away from the material of the ring 10, providing access to the loop of filament 12, see systemic component 708. Once accessible, the filament 12 can be moved from the joined-together coiled condition to an uncoiled condition or partially uncoiled condition to be used as a saw to saw through the common restraints.

In some embodiments, the exterior circumferential surface of the ring 10 may provide a recessed channel 13 in which the loop of filament 12 is nested. Alternatively, the loop of filament 12 may be embedded in a continuous groove in the material of the ring 10 and/or along an interior circumferential surface of the cover layer 14.

In the loop condition, portions of the filament 12 may be tied or adhered together to maintain the shape of the endless loop when embedded in a body of the ring 12, while being easily unfurled to the extended, uncoiled condition for ready for sawing when held taut between two hands of a hand and a clamped mouth. The present invention is ideal for military, governmental and general travelers in more dangerous locations stateside and abroad.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A method of conceal carry of a wire saw, the method comprises:
embedding the wire saw in a ring dimensioned and shaped to inconspicuously be worn on a finger of a wearer, wherein the wire saw is in a coiled condition movable to an uncoiled condition for sawing.

2. The method of claim 1, further comprising covering the ring with a layer that makes the wire saw invisible.

3. A wearable concealed saw device comprising:
a ring configured to be inconspicuously worn on a finger of a wearer; and
a wire saw, in a coiled condition, embedded in a body of the ring, wherein the wire saw is movable to an uncoiled condition for sawing after being removed from the body of the ring.

4. The wearable concealed saw device of claim 3, wherein the wire saw comprises a diamond cutting saw wire.

5. The wearable concealed saw device of claim 3, further comprising:
an arcuate cover layer snugly circumscribing an exterior surface of the ring, thereby encasing the wire saw.

6. The wearable concealed saw device of claim 3, wherein the ring is made of silicone.

7. The wearable concealed saw device of claim 5, wherein the ring and the cover layer are made of silicone.

8. The wearable concealed saw device of claim 7, wherein the silicone is colored to match a skin color of the wearer.

9. The wearable concealed saw device of claim 6, wherein a recessed channel is provided along the exterior surface of the ring for nesting the wire saw in the coiled condition.

10. The wearable concealed saw device of claim 3, wherein the wire saw is adhered in the coiled condition.
